(19) United States
(12) Patent Application Publication
(10) Pub. No.: US 2023/0385025 A1
(43) Pub. Date: Nov. 30, 2023

(54) METHOD AND APPARATUS WITH REPEATED MULTIPLICATION

(71) Applicants: SAMSUNG ELECTRONICS CO., LTD., Suwon-si (KR); Industry-Academic Cooperation Foundation, Yonsei University, Seoul (KR)

(72) Inventors: Ho Young KIM, Suwon-si (KR); Won Woo RO, Seoul (KR); Se Hyun YANG, Suwon-si (KR); Dong Ho HA, Seoul (KR)

(73) Assignees: SAMSUNG ELECTRONICS CO., LTD., Suwon-si (KR); Industry-Academic Cooperation Foundation, Yonsei University, Seoul (KR)

(21) Appl. No.: 18/187,971

(22) Filed: Mar. 22, 2023

(30) Foreign Application Priority Data
May 26, 2022 (KR) 10-2022-0064714

(51) Int. Cl. G06F 7/544

(52) U.S. Cl. CPC G06F 7/5443

(57) ABSTRACT

A processing device including a first buffer storing calculation rules, a calculator including a plurality of multipliers and an adder, the multipliers configured to perform multiplication repeatedly, a second buffer storing operands, the second buffer being configured to enqueue the operands based on the calculation rules into a queue, and a counter indicating a respective number indicating a number of times a multiplication is to be performed by each of the plurality of multipliers, each multiplier of the plurality of multipliers being configured to provide a non-final multiplication result to a first path to an input of the corresponding multiplier responsive to a corresponding number of multiplications performed by the multiplier being less than the respective number, and provide a final multiplication result to a second path to the adder responsive to the corresponding number of multiplications performed by the multiplier being equal to the respective number.

### CROSS-REFERENCE TO RELATED APPLICATIONS

This application claims the benefit under 35 USC §119(a) of Korean Patent Application No. 10-2022-0064714, filed on May 26, 2022, at the Korean Intellectual Property Office, the entire disclosure of which is incorporated herein by reference for all purposes.

### BACKGROUND

### 1. Field

The following description relates to a method and apparatus with repeated multiplication.

### 2. Description of Related Art

Typically, various accelerators are being used in the field of artificial intelligence (AI).

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a general aspect, here is provided a device including a first buffer storing calculation rules, a calculator including a plurality of multipliers and an adder, each of the plurality of multipliers being configured to perform multiplication repeatedly, a second buffer storing operands of the calculator, the second buffer being configured to enqueue the operands based on the calculation rules into a queue of the calculator, and a counter indicating a respective number indicating a number of times a multiplication is to be performed by each of the plurality of multipliers, each multiplier of the plurality of multipliers is configured to provide a non-final multiplication result to a first path to an input of a corresponding multiplier responsive to a corresponding number of multiplications performed by the corresponding multiplier being less than the respective number and provide a final multiplication result to a second path to the adder responsive to the corresponding number of multiplications performed by the corresponding multiplier being equal to the respective number.

Each of the plurality of multipliers is configured to, upon receiving the non-final multiplication result through the first path to receive an operand corresponding to a current multiplication order from the queue and to perform multiplication on the non-final multiplication result and the received operand.

Each of the plurality of multipliers is configured to, when the corresponding number multiplications performed is equal to the indicated number of times, transmit a derived multiplication result, as the final multiplication result, to the adder through the second path.

The calculator may include a register receiving and storing an added operand on which multiplication is not to be performed among the operands from the queue.

The calculator may be configured to sum the added operand stored in the register and an output value of the adder.

The first buffer may be configured to transmit the number of times multiplication is to be performed by each of the plurality of multipliers to the counter.

The second buffer is configured to, when at least one multiplier of the plurality of multipliers performs a power calculation of a given operand, map a number of times the given operand is repeatedly multiplied with the given operand and enqueue the given operand into the queue.

Each of the first buffer and second buffer may be configured to store an output of each of the plurality of multipliers, and the calculator may include a third buffer storing an output of the adder.

In another general aspect, here is provided an electronic device including a host processor, a memory storing operands, and a processor configured to receive a command from the host processor, receive the operands from the memory, and perform a calculation on the received operands based on the received command, wherein the processor includes a first buffer storing calculation rules, a calculator including a plurality of multipliers an adder, each of the plurality of multipliers being configured to perform multiplication repeatedly, a second buffer storing the received operands and enqueuing the received operands based on the calculation rules into a queue of the calculator, and a counter indicating a number of times a multiplication is to be performed by each of the plurality of multipliers, each of the plurality of multipliers are configured to provide to a first path to be input to each of the plurality of multipliers responsive to a corresponding number of multiplications performed by the multiplier being less than the respective number and provide to a second path to be input to the adder responsive to the number of multiplications performed by the multiplier is equal to the respective number.

Each of the plurality of multipliers is configured to responsive to a number of multiplications performed by the multiplier is less than the respective number receive a derived multiplication result through the first path, receive an operand corresponding to a current multiplication order from the queue, and perform multiplication on the derived multiplication result and the received operand.

Each of the plurality of multipliers is configured to, responsive to the corresponding number of multiplications performed by the multiplier is equal to the respective number, transmit the derived multiplication result to the adder through the second path.

The calculator further may also include a register receiving and storing an added operand on which multiplication is not to be performed from the queue among the operands enqueued into the queue.

The calculator may be configured to sum the added operand stored in the register and an output value of the adder.

The first buffer may be configured to transmit the number of times the multiplication is to be performed by each of the plurality of multipliers to the counter.

The second buffer may be configured to, when at least one multiplier of the plurality of multipliers performs a power calculation of a given operand, map a number of times the given operand is repeatedly multiplied with the given operand and enqueue the given operand into the queue.

The calculator may include a plurality of buffers configured to store an output of each of the plurality of multipliers, respectively and an output buffer configured to store an output of the adder.

The host processor may be configured to generate the calculation rules while compiling source code and the processor may be configured to store the calculation rules in the first buffer.

In another general aspect, here is provided a processor implemented method, the method including enqueuing operands based on calculation rules into a queue of a calculator, indicating a number of times multiplication is to be performed by each of a plurality of multipliers, providing a non-final output, for each of the plurality of multipliers, through a first path to an input of the respective multiplier, and providing a final output, for each of the plurality of multipliers to an adder through a second path.

The method may include mapping a number of times a given operand is repeatedly multiplied with the given operand and enqueueing the given operand into the queue when at least one of the multipliers performs a power calculation of a given operand.

Each of the plurality of multipliers is configured to provide to the first path responsive to a number of multiplications performed being less than the indicated number and provide to the second path responsive to the number of multiplications performed being equal to the indicated number.

Other features and aspects will be apparent from the following detailed description, the drawings, and the claims.

### BRIEF DESCRIPTION OF THE DRAWINGS

FIG. 1 illustrates a diagram of an accelerator and a host according to one or more embodiments;

FIG. 2 illustrates a block diagram of an accelerator according to one or more embodiments;

FIGS. 3A to 6 illustrate diagrams of an operation of a processing core in an accelerator according to one or more embodiments;

FIGS. 7 to 9 illustrate diagrams of an operation of a processing core in an accelerator according to one or more embodiments;

FIG. 10 illustrates a diagram of a processing device according to one or more embodiments;

FIG. 11 illustrates a block diagram of an electronic device according to one or more embodiments; and

FIG. 12 illustrates a flowchart of a method of operating a processing device according to one or more embodiments.

Throughout the drawings and the detailed description, unless otherwise described or provided, the same drawing reference numerals may be understood to refer to the same, or like, elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Throughout the specification, when a component or element is described as being “on”, “connected to,” “coupled to,” or “joined to” another component, element, or layer it may be directly (e.g., in contact with the other component or element) “on”, “connected to,” “coupled to,” or “joined to” the other component, element, or layer or there may reasonably be one or more other components, elements, layers intervening therebetween. When a component or element is described as being “directly on”, “directly connected to,” “directly coupled to,” or “directly joined” to another component or element, there can be no other elements intervening therebetween. Likewise, expressions, for example, “between” and “immediately between” and “adjacent to” and “immediately adjacent to” may also be construed as described in the foregoing.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated features, numbers, operations, members, elements, and/or combinations thereof are not present. Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein. The use of the term “may” herein with respect to an example or embodiment, e.g., as to what an example or embodiment may include or implement, means that at least one example or embodiment exists where such a feature is included or implemented, while all examples are not limited thereto.

AI applications typically include matrix multiplication calculations (MMCs). Some accelerators may include tensor cores that perform these MMC's and may support the acceleration of the AI applications through the tensor cores. A typical tensor core in a conventional GPU may be employed to accelerate general matrix to matrix multiplication (GEMM) in a deep learning application. However, there may be some applications that do not use GEMM, and accordingly, the conventional GPU may not be able to handle applications that do not use GEMM. In addition, the conventional tensor core may not perform asymmetric dot product (ADP) calculations as described below. One or more embodiments may employ feedback paths in relation to example tensor cores which may provide enhanced MMC and ADP calculations for deep learning AI applications.

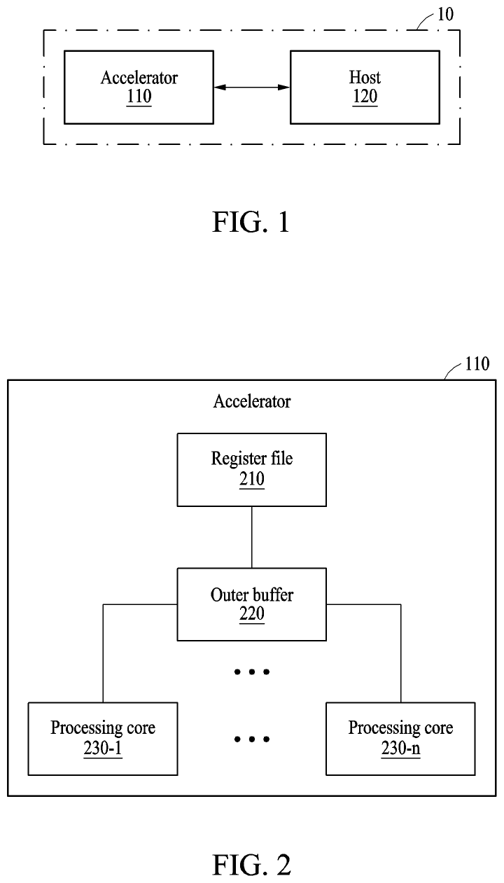

FIG. 1 illustrates a diagram of an electronic device with an accelerator and a host according to one or more embodiments.

Referring to FIG. 1, an electronic device 10 may include a host 120 which may generate a binary code (or a binary file) by compiling an application and may transmit the generated binary code to an accelerator 110. In a non-limiting example, either one of the host 120 and the accelerator 110 may be provided separately outside of the electronic device

Herein, electronic devices, such as electronic device 10, as well as each of the accelerator 110 and host 120, are representative of one or more processors, or one or more processors and a memory storing instructions, configured to implement one or more, or any combination of, operations or methods described herein. The one or more processors may be respective special purpose hardware-based computers or other special-purpose hardware. The one or more processors may be configured to execute such instructions. The one or more memories may store the instructions, which when executed by the one or more processors configure the one or more processors to perform one or more, or any combination of operations of methods described herein.

The host 120 may include, for example, a central processing unit (CPU) or any other processing device or processors. The host 120 may also be referred to as a host processor.

The accelerator 110 may be a hardware accelerator for performing or accelerating a calculation of an application. The accelerator 110 may execute the binary code received from the host 120.

The accelerator 110 may be, for example, a graphics processing unit (GPU) or a neural processing unit (NPU) but is not limited thereto. The accelerator 110 and the host 120 may be implemented as a single chip. Alternatively, in other non-limiting examples, the accelerator 110 may be implemented as a separate chip physically independent from the host 120. While a neural network and NPU will be discussed herein, these are only examples, and embodiments may include other machine learning models with other processor hardware where the non-limiting examples of ADP and/or MMC, or other related operations are otherwise implemented, as non-limiting examples. The accelerator 110 may perform general matrix to matrix multiplication (GEMM) of a deep learning application. In addition, the accelerator 110 may perform calculations (e.g., multiply-add (MAD) or asymmetric dot product (ADP)) of an application that does not use GEMM. Some equations may include a plurality of terms, and the number of times each term is multiplied may not be the same. In examples where calculations in which the number of times each term is multiplied are not the same may be referred to herein as an “ADP.” For example, in “x·y·z+a·b”, the number of times a first term (x·y·z) is multiplied is 2, and the number of times a second term (a·b) is multiplied is 1, and the number of times each term is multiplied is therefore not the same. This example calculation is an example of an ADP calculation.

The accelerator 110 according to an example embodiment may perform ADP when receiving a command for ADP from the host 110. Hereinafter, the accelerator 110 performing ADP will be described.

FIG. 2 illustrates a block diagram of an accelerator according to one or more embodiments.

Referring to FIG. 2, the accelerator 110 may include a register file 210, an outer buffer 220, and a plurality of processing cores (230-1 to 230-n).

The accelerator 110 may receive one or more commands from the host 120, access a memory (not shown) (e.g., dynamic random access memory (DRAM)) to read operands from the memory, and store the operands in the register file 210. The operands may be input to the processing cores 230-1 to 230-n, and the processing cores 230-1 to 230-n may perform a calculation (e.g., ADP) based on the operands. The operands may be expressed differently as input values or input data of the processing cores 230-1 to 230-n.

The accelerator 110 may divide operands stored in the register file 210 into operands of each of the processing cores 230-1 to 230-n, and store the operands of each of the processing cores 230-1 to 230-n in the outer buffer 220.

Each of the processing cores 230-1 to 230-n may receive its operands from the outer buffer 220. Each of the processing cores 230-1 to 230-n may perform a calculation (e.g., ADP) based on its operands. An example of an operation of the processing core 230-1 will be described below. Each of the other processing cores in the accelerator 110 may operate in the same manner as the processing core 230-1. The description of the processing core 230-1 may apply to each of the other processing cores in the accelerator 110.

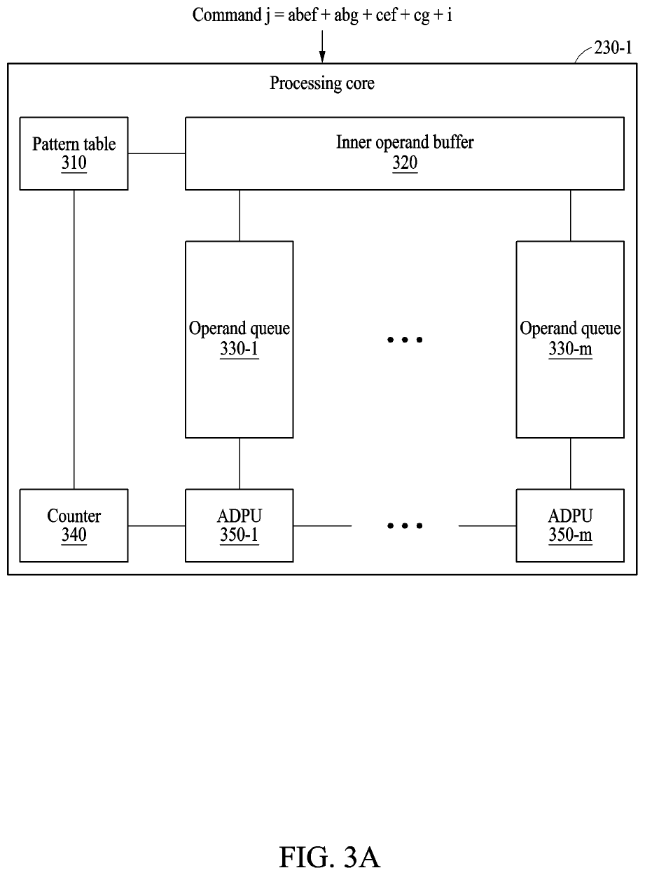

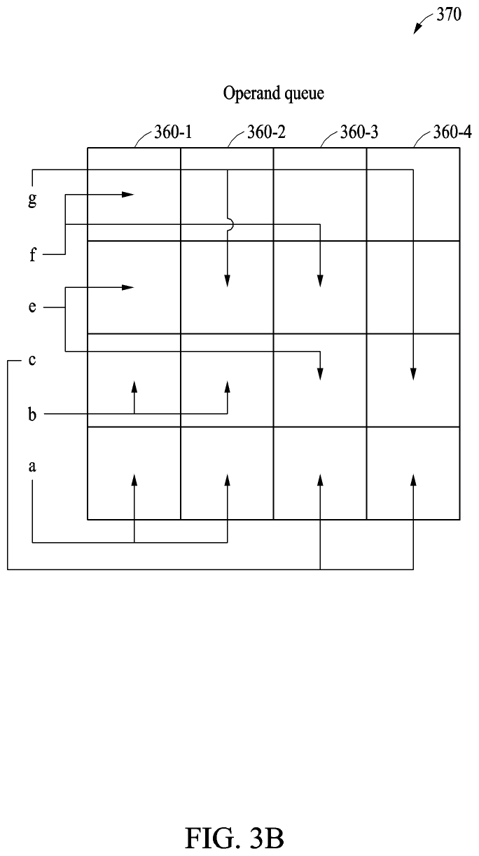

FIGS. 3A to 6 illustrate diagrams of an operation of a processing core in an accelerator according to one or more embodiments.

Referring to FIG. 3A, the processing core 230-1 may include a pattern table 310, an inner operand buffer 320, operand queues 330-1 to 330-m, a counter 340, and asymmetric dot product units (ADPUs) 350-1 to 350-m.

Each of the ADPUs 350-1 to 350-m may include multipliers that perform multiplication repeatedly and one or more adders. As will be described in detail below, in an example, each of the multipliers may output to a first path where that output will be re-input to a corresponding multiplier. In an example, each of the multipliers may output to a second path which may be input to the adder. Each of the multipliers may receive its output through the first path when the number of times it performs multiplication is less than the number of times of multiplication indicated by the counter 340. That is, the multiplier may output to first path for as long as the multiplier is instructed to multiply its value. Each of the multipliers may transmit its output to the adder through the second path when the number of times it performs multiplication is equal to the number of times of multiplication indicated by the counter 340. That is, when the multiplier has completed its tasked multiplication it may output to the second path.

Each of the ADPUs 350-1 to 350-m may be represented differently as a calculator or a calculation circuit.

The processing core 230-1 may store a calculation rule in the pattern table 310. The calculation rule may represent a rule in which the processing core 230-1 enqueues an operand into a given operand queue. For example, the host 120 may transmit “command j=a·b·e·f +a·b·g+c·e·f+c·g+i” to the accelerator 110. In the example illustrated in FIG. 3B, while compiling the source code, the host 120 may find the following calculation rules such that an operand a is enqueued into a first entry of a first column 360-1 and a first entry of a second column 360-2 of a given operand queue 370, an operand b is enqueued into a second entry of the first column 360-1 and a second entry of the second column 360-2, an operand c is enqueued into a first entry of a third column 360-3 and a first entry of a fourth column 360-4, an operand e is enqueued into a third entry of the first column 360-1 and a second entry of the third column 360-3, an operand f is enqueued into a fourth entry of the first column 360-1 and a third entry of the third column 360-3, and an operand g is enqueued into a second entry of the fourth column 360-4. As will be described below in greater detail, the processing core 230-1 may enqueue operands of each of the ADPUs 350-1 to 350-m in each of the operand queues 330-1 to 330-m according to the calculation rules.

Referring back to FIG. 3A, the pattern table 310 may be a buffer.

The host 120 may generate a binary code by compiling the source code and transmitting the generated binary code to the accelerator 110. In this case, the generated binary code may include the above-described calculation rules. The accelerator 110 may store the calculation rules in the binary code into the pattern table 310.

Returning to FIG. 3A, the pattern table 310 may transmit the number of times that a multiplication is to be performed by each of the multipliers to each of the ADPUs 350-1 to 350-m to the counter 340. Each of the multipliers in the ADPUs 350-1 to 350-m may perform multiplication by the indicated number of times.

The processing core 230-1 may receive operands of the processing core 230-1 from the outer buffer 220 and store the received operands in the inner operand buffer 320. The processing core 230-1 may enqueue operands stored in the inner operand buffer 320 into the operand queues 330-1 to 330-m based on a calculation rule in the pattern table 310.

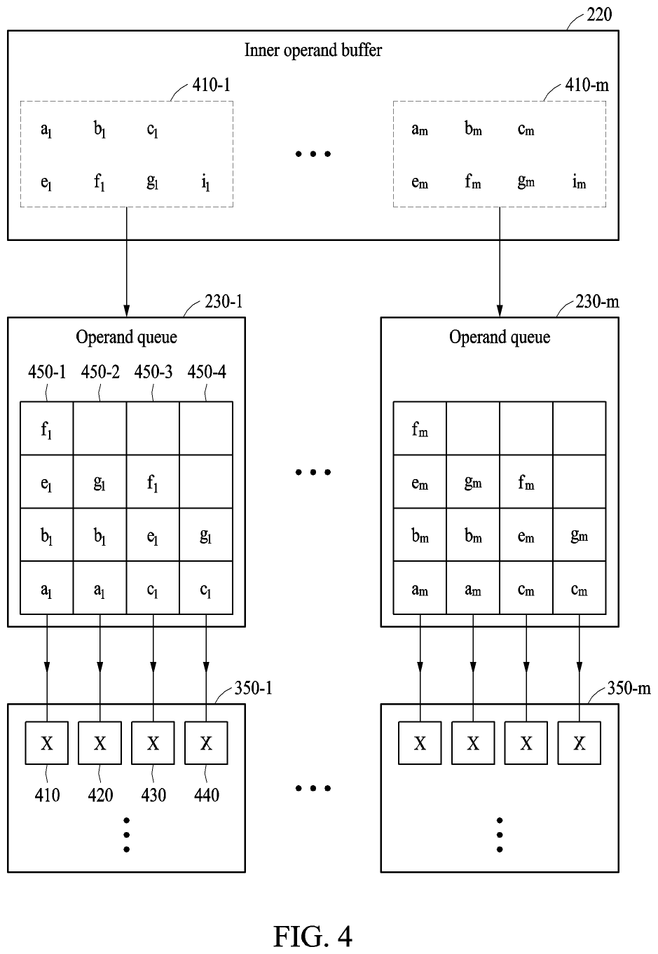

In the example illustrated in FIG. 4, the processing core 230-1 may receive operands (a₁˜aₘ, b₁˜bₘ, g₁˜gₘ, of the processing core 230-1 from the outer buffer 220. The processing core 230-1 may divide (or classify) operands stored in the outer buffer 220 into operands 410-1 (a₁, b₁, c₁, e₁, f₁, g₁, of the operand queue 230-1 (or the ADPU 250-1) or into operands 410-m (aₘ, bₘ, cₘ, eₘ, fₘ, gₘ, iₘ) of the operand queue 230-m (or the ADPU 250-m) based on the calculation rule in the pattern table 310 and store the operands in the inner operand buffer 220.

In the example illustrated in FIG. 4, the processing core 230-1 may enqueue (or insert) operands 410-1 (a₁, b₁, c₁, e₁, f₁, g₁, into the operand queue 230-1 based on the calculation rule in the pattern table 310. As illustrated in FIG. 4, the processing core 230-1 may sequentially fill a first column 450-1 of the operand queue 230-1 with operands (a₁, b₁, e₁, f₁) with reference to the calculation rule in the pattern table 310 and may sequentially fill a second column 450-2 with operands (a₁, b₁, g₁). The processing core 230-1 may sequentially fill a third column 450-3 with operands (c₁, e₁, f₁), and may sequentially fill a fourth column 450-4 with operands (c₁, g₁).

The processing core 230-1 may fill “1” in each of the empty entries of the operand queue 230-1.

Similarly, in the example illustrated in FIG. 4, the processing core 230-1 may enqueue operands 410-m (aₘ, bₘ, cₘ, eₘ, fₘ, gₘ, iₘ) into the operand queue 230-m based on the calculation rule in the pattern table 310 and fill “1” in each of the empty entries of the operand queue 230-m. Although ii is not in the operand queue 230-1 as illustrated in FIG. 4, this does not limit other examples to mean that the operand queue 230-1 does not store i₁. Similarly, although iₘ is not in the operand queue 230-m as illustrated in FIG. 4, this does not mean that the operand queue 230-m does not store iₘ. As described above, in one or more examples, the operand queue 230-1 stores i₁, and the operand queue 230-m stores iₘ.

Returning to FIG. 3A, the counter 340 may indicate the number of times multiplication is to be performed by each of the multipliers to each of the ADPUs 350-1 to 350-m. In the example illustrated in FIG. 4, the counter 340 may communicate an indication to the ADPU 350-1 that each of multipliers 410 to 440 should perform multiplication three times in total. That is, the counter 340 may indicate to the ADPU 350-1 that a first multiplier 410 should perform multiplication three times in total in order to output a₁·b₁·e₁·f₁ as a final multiplication result. The counter 340 may indicate to the ADPU 350-1 that a second multiplier 420 should perform multiplication three times in total to output a₁·b₁·g₁1 as a final multiplication result. Similarly, the counter 340 may indicate to the ADPU 350-1 that each of a third multiplier 430 and a fourth multiplier 440 should perform multiplication three times in total. Similarly, the counter 340 may indicate to the ADPU 350-m that each of the multipliers should perform multiplication three times in total.

The ADPU 350-1 may receive operands (a₁, a₁, c₁, c₁) corresponding to the first order and may receive operands (b₁, b₁, e₁, g₁) corresponding to the second order from the operand queue 230-1.

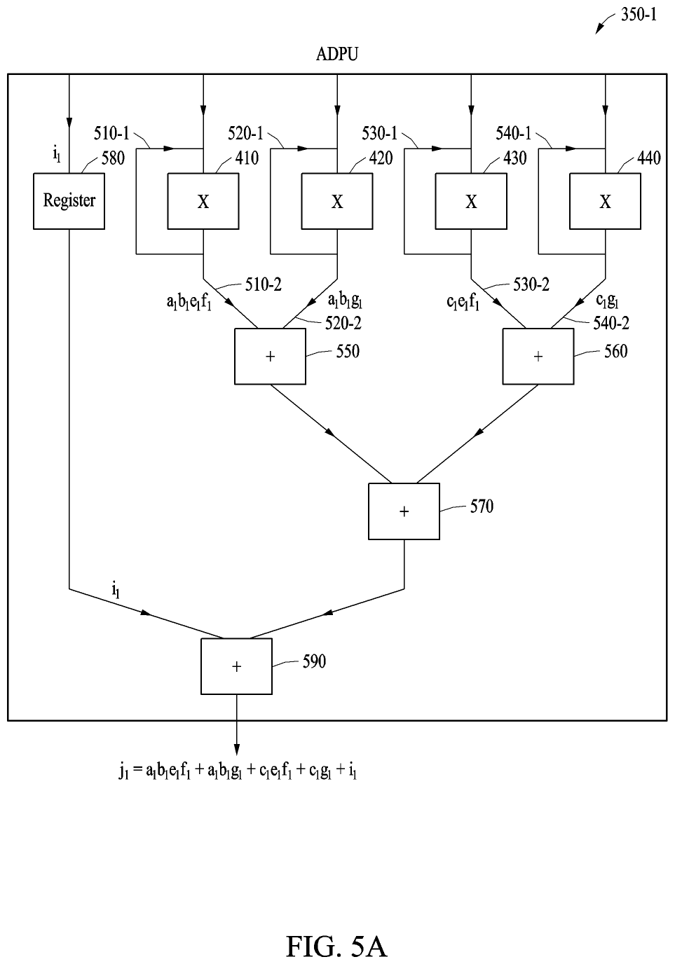

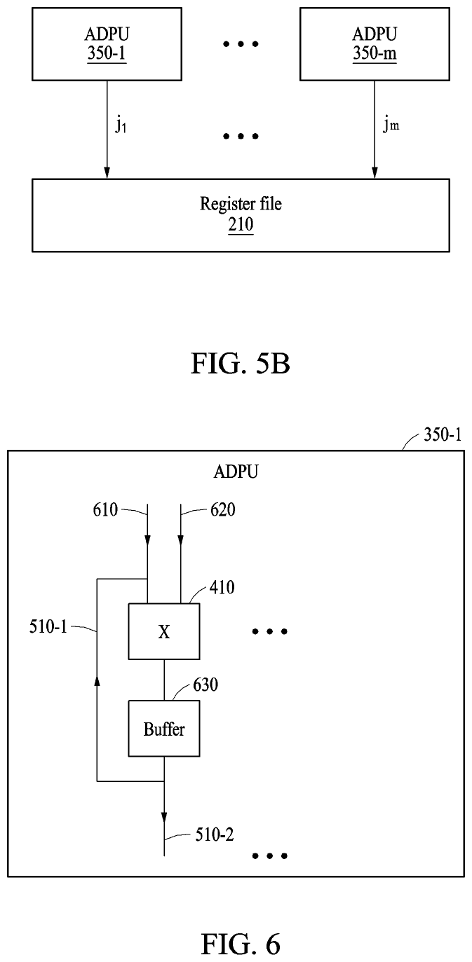

Each of the multipliers 410 to 440 may perform a multiplication (or a 1st multiplication) on the operands of the first order and the operands of the second order. In the example illustrated in FIG. 5A, the first multiplier 410 may perform multiplication on the operand (a₁) and the operand (b₁) to derive a multiplication result (a₁·b₁), and the second multiplier 420 may perform multiplication on the operand (a₁) and the operand (b₁) to derive a multiplication result (a₁·b₁). The third multiplier 430 may perform multiplication on the operand (c₁) and the operand (e₁) to derive a multiplication result (c₁·e₁), and the fourth multiplier 440 may perform multiplication on the operand (c₁) and the operand (g₁) to derive a multiplication result (c₁·g₁). In a non-limiting example, the multiplication results may be non-final when further multiplication (e.g., one or more) on the results are to be performed by the respective multiplier.

In the example illustrated in FIG. 5A, the number of times that the multiplication is performed may be one, in this example, and may be less than the indicated number of times (three times). In this case, the first multiplier 410 may receive the multiplication result (a₁·b₁) through a first path 510-1. That is, in this example, the multiplication result (a₁·b₁) is non-final. Similarly, each of the remaining multipliers 420 to 440 may receive a multiplication result through each of first paths 520-1, 530-1, and 540-1.

The multipliers 410 to 440 may receive operands (e₁, g₁, f₁, 1) of the third order from the operand queue 230-1. Each of the multipliers 410 to 440 may perform multiplication (or 2nd multiplication) on a multiplication result received through each of the third order operands and the first paths 510-1, 520-1, 530-1, and 540-1. That is, the first multiplier 410 may perform multiplication on the multiplication result (a₁·b₁) received through the third order operand (e₁) and the first path 510-1 to derive a multiplication result (a₁·b₁·e₁), and the second multiplier 410 may perform multiplication on the multiplication result (a₁·b₁) received through the third order operand (g₁) and the first path 510-2 to derive a multiplication result (a₁·b₁·g₁). The third multiplier 430 may perform multiplication on the multiplication result (c₁·e₁) received through the third order operand (f₁) and the first path 510-3 to derive a multiplication result (c₁·e₁·f₁), and the fourth multiplier 440 may perform multiplication on the multiplication result (c₁·g₁) received through the third order operand (1) and the first path 510-4 to derive a multiplication result (c₁·g₁). The number of times the multiplication is performed may be two, in this example, and may be less than the indicated number of times (three times). In this case, the first multiplier 410 may receive the multiplication result (a₁·b₁·e₁) through the first path 510-1. Similarly, each of the remaining multipliers 420 to 440 may receive a multiplication result through each of the first paths 520-1, 530-1, and 540-1.

The multipliers 410 to 440 may receive operands (f₁, 1, 1, 1) of a fourth order from the operand queue 230-1. The first multiplier 410 may perform multiplication (or 3rd multiplication) to the multiplication result (a₁·b₁·e₁) received through the fourth order operand (f₁) and the first path 510-1 to derive a multiplication result (a₁·b₁·e₁·f₁). Similarly, each of the remaining multipliers 420 to 440 may perform multiplication.

The number of times each of the multipliers 410 to 440 performs multiplication may be three, in this example, and may be equal to the indicated number of times (three times). In this case, the first multiplier 410 may transmit the final multiplication result (a₁·b₁·e₁·f₁) to an adder 550 and the second multiplier 420 may transmit the final multiplication result (a₁·b₁·g₁) to the adder 550. The third multiplier 430 may transmit the final multiplication result (c₁·e₁·f₁) to an adder 560 and the fourth multiplier 440 may transmit the final multiplication result (c₁·g₁) to the adder 560.

The adder 550 may sum the final multiplication result (a₁·b₁·e₁·f₁) of the first multiplier 410 and the final multiplication result (a₁·b₁·g₁) of the second multiplier 420 and may transmit the sum result to an adder 570.

The adder 560 may sum the final multiplication result (c₁·e₁·f₁) of the third multiplier 430 and the final multiplication result (c₁·g₁) of the fourth multiplier 440 and transmit the sum result to the adder 570.

The adder 570 may sum the sum result of the adder 550 and the sum result of the adder 560 and may transmit the sum result of the adder 570 itself to an adder 590.

In an example, a register 580 may receive and store the operand (i₁) on which multiplication is not to be performed among operands of the ADPU 350-1 from the operand queue 230-1. The operand on which no multiplication is to be performed may be referred to as an added operand.

The adder 590 may receive the operand (i₁) from the register 580 and may perform summing on the sum result of the operand (i₁) and the adder 570.

The adder 590 (or the ADPU 350-1) may store the calculation result (j₁) in the register file 210 as illustrated in FIG. 5B. Similarly, the ADPU 350-m may store the calculation result (jₘ) in the register file 210. The register file 210 may store the final calculation results (j₁to jₘ) of each of the ADPUs 350-1 to 350-m.

FIG. 6 illustrates an example of the multiplier 410 in the ADPU 350-1 and a buffer 630 connected to an output terminal of the multiplier 410 according to one or more embodiments. In the example illustrated in FIG. 6, the multiplier 410 may receive the operand (a₁) from the operand queue 230-1 through a first input path 610 and receive the operand (b₁) from the operand queue 230-1 through a second input path 620.

The multiplier 410 may perform multiplication (1st multiplication) on the operand (a₁) and the operand (b₁) to derive a multiplication result (a₁·b₁), and may store the multiplication result (a₁·b₁) in the buffer 630. The multiplier 410 may receive the multiplication result (a₁·b₁) stored in the buffer 630 through the first path 510-1 when the number of times multiplication is performed (one time) is less than the indicated number of times (three times) and may receive the operand (e₁) from the operand queue 230-1 through the second input path 620.

The multiplier 410 may perform multiplication (2nd multiplication) on the multiplication result (a₁·b₁) and the operand (e₁) to derive a multiplication result (a₁·b₁·e₁), and may store the multiplication result (a₁·b₁·e₁) in the buffer 630. The multiplier 410 may receive the multiplication result (a₁·b₁·e₁) stored in the buffer 630 through the first path 510-1 when the number of times multiplication is performed (two times) is less than the indicated number of times (three times), and may receive the operand (f₁) from the operand queue 230-1 through the second input path 620.

The multiplier 410 may perform multiplication (3rd multiplication) on the multiplication result (a₁b₁e₁) and the operand (f₁) to derive a multiplication result (a₁·b₁·e₁·f₁), and may store the multiplication result (a₁b₁e₁f₁) in the buffer 630. The multiplier 410 may transmit the multiplication result (a₁·b₁·e₁·f₁) stored in the buffer 630 to the adder 550 through the second path 510-2 when the number of times multiplication is performed (three times) is equal to the indicated number of times (three times).

Similar to the multiplier 410, an output terminal of each of the remaining multipliers 410, 420, and 430 may be connected to a buffer of each of the remaining multipliers 410, 420, and 430. The description of the operation of the multiplier 410 with reference to FIG. 6 may apply to each of the remaining multipliers 410, 420, and 430, and thus detailed descriptions of each of the remaining multipliers 410, 420, and 430 will be omitted.

Although not shown in FIG. 6, in a non-limiting example, an output terminal of one or more or all of the adders 550, 560, 570, and 590 may be connected to the buffer. Calculation results of each of the adders 550, 560, 570, and 590 may be stored in the buffer connected to each of the adders 550, 560, 570, and 590.

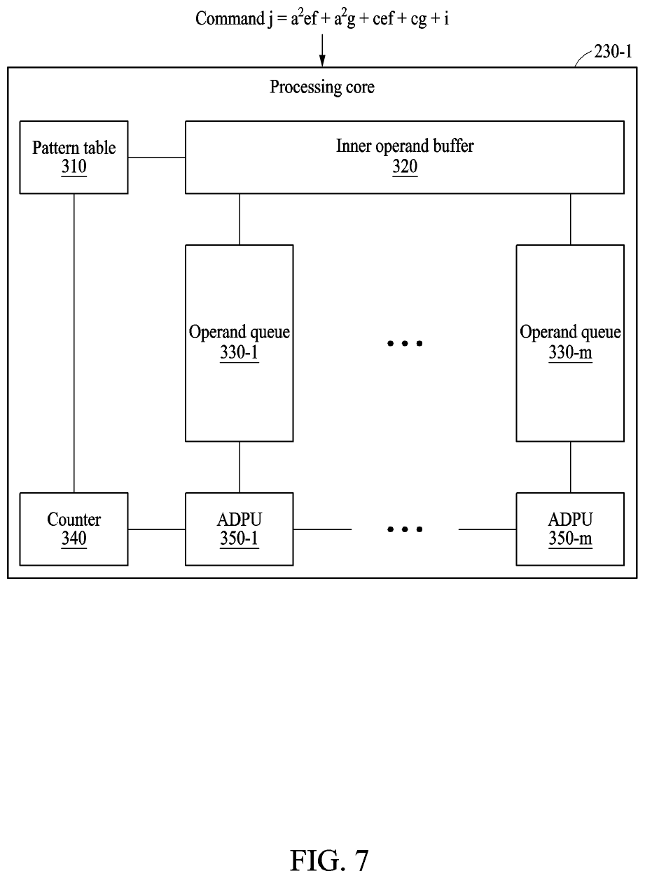

FIGS. 7 to 9 illustrate other diagrams of an operation of a processing core in an accelerator according to one or more embodiments.

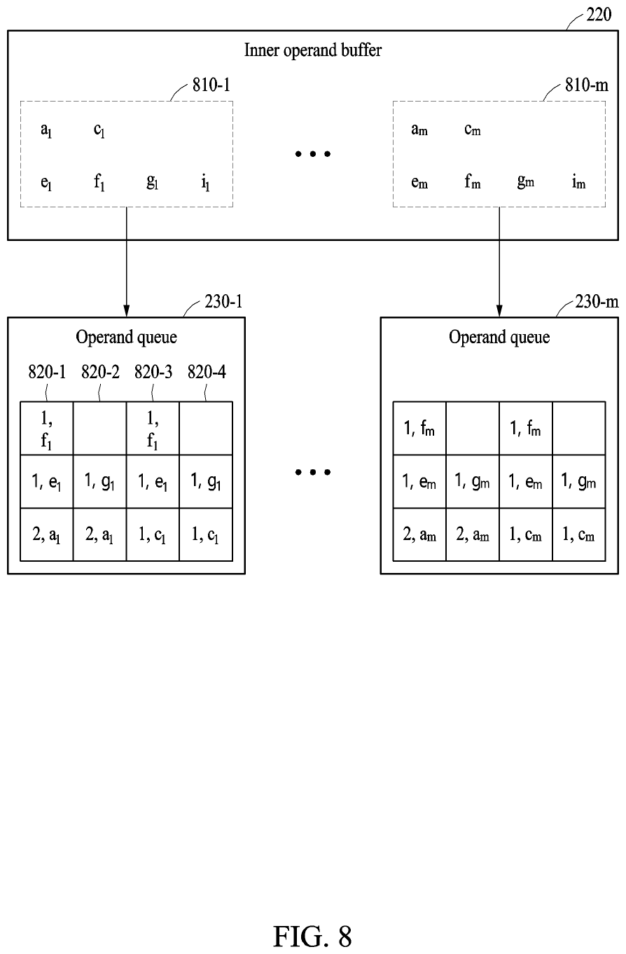

Referring to FIGS. 7 to 8, it is described that the accelerator 110 performs ADP including a power calculation of the operand. An example of a power calculation, a square calculation of an operand will be described below.

Referring to FIG. 7, the host 120 may receive “command j=a²·e·f+a²·g+c·e·f+c·g+i” from the accelerator 110. The host 120, while compiling the source code, may follow the calculation rules that “the number of times the operand (a) and the operand (a) are repeatedly multiplied (e.g., 2) is enqueued into a first entry of the first column 360-1 and a first entry of the second column 360-2 of the given operand queue 370, the number of times operand (c) and operand (c) are repeatedly multiplied (e.g., 1) is enqueued into a first entry of the third column 360-3 and a first entry of the fourth column 360-4, the number of times the operand (e) and the operand (e) are repeatedly multiplied (e.g., 1) is enqueued into a second entry of the first column 360-1 and a second entry of the third column 360-3, the number of times the operand (f) and the operand (f) are repeatedly multiplied (e.g., 1) is enqueued into a third entry of the first column 360-1 and a third entry of the third column 360-3, and the number of times the operand (g) and the operand (g) are repeatedly multiplied (e.g., 1) is enqueued into a second entry of the second column 360-2 and a second entry of the fourth column 360-4”.

The accelerator 110 may receive a binary code including a calculation rule from the host 120 and may store the calculation rule in the pattern table 310.

The pattern table 310 may transmit the number of times multiplication is to be performed by each of the multipliers for each of the ADPUs 350-1 to 350-m to the counter 340.

The processing core 230-1 may receive operands of the processing core 230-1 from the outer buffer 220 and store the received operands in the inner operand buffer 320. The processing core 230-1 may enqueue operands stored in the inner operand buffer 320 and the number of times each operand is repeatedly multiplied in the operand queues 330-1 to 330-m based on the calculation rule in the pattern table 310.

In an example illustrated in FIG. 8, the processing core 230-1 may receive operands (a₁˜aₘ, c₁˜cₘ, e₁˜eₘ, of the processing core 230-1 from the outer buffer 220. The processing core 230-1 may divide (or classify) operands stored in the outer buffer 220 into operands 810-1 (a₁, c₁, e₁, f₁, g₁, i₁) of the operand queue 230-1 (or the ADPU 250-1) or operands 810-m (aₘ, cₘ, eₘ, fₘ, gₘ, iₘ) of the operand queue 230-m (or the ADPU 250-m) based on the calculation rule in the pattern table 310 and store the operands in the inner operand buffer 220.

In the example illustrated in FIG. 8, the processing core 230-1 may enqueue (or insert) operands 810-1 (a₁, c₁, e₁, f₁, g₁, i₁) and the number of times multiplication is to be repeated for each operand (a₁, c₁, e₁, f₁, g₁) on which multiplication is performed into the operand queue 230-1 based on the calculation rule in the pattern table 310. The processing core 230-1, referring to the calculation rule in the pattern table 310, may fill a first entry of a first column 820-1 of the operand queue 230-1 with 2 and (a₁), fill a second entry of the first column 820-1 with 1 and (e₂), and fill a third entry of the first column 820-1 with 1 and (f₁). Similarly, the processing core 230-1 may fill remaining columns 820-2 to 820-4 referring to the calculation rule in the pattern table 310. The processing core 230-1 may fill “1” in each of the empty entries of the operand queue 230-1

Similarly, in the example illustrated in FIG. 8, the processing core 230-1 may enqueue operands 810-m (aₘ, cₘ, eₘ, fₘ, gₘ, iₘ) and the number of times the multiplication is repeated for each of operands (aₘ, cₘ, eₘ, fₘ, gₘ) on which multiplication is performed into the operand queue 230-m based on the calculation rule in the pattern table 310. In addition, the processing core 230-1 may fill “1” in each of the empty entries of the operand queue 230-M.

The counter 340 may indicate the number of times multiplication is to be performed by each multiplier to each of the ADPUs 350-1 to 350-m. In the example illustrated in FIG. 8, the counter 340 may indicate to the ADPU 350-1 that each of the multipliers 410 to 440 should perform multiplication three times in total. Similarly, the counter 340 may indicate to the ADPU 350-m that each of the multipliers of the ADPU 350-m should perform multiplication three times in total.

The ADPU 350-1 may receive the number of times multiplication is to be repeated for each of the operands (a₁, a₁, c₁, c₁) and the operands (a₁, a₁, c₁, c₁) from the operand queue 230-1.

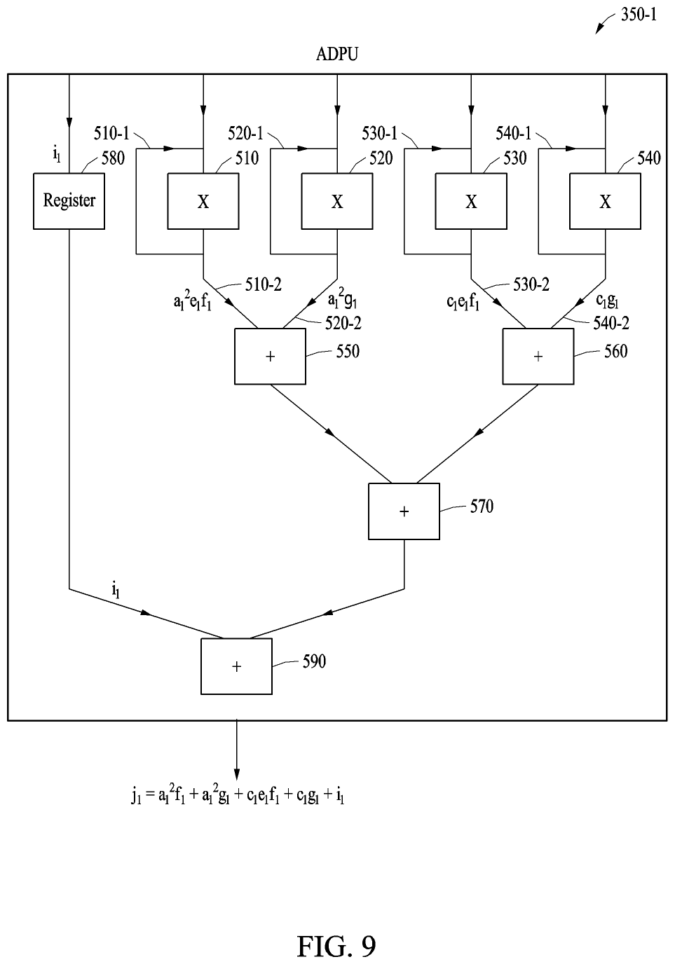

Each of the multipliers 410 to 440 of FIG. 5A, for example, may perform a square calculation of each of the operands (a₁, a₁, c₁, c₁) using the number of times multiplication is to be repeated for each of the operands (a₁, a₁, c₁, c₁) and the operands (a₁, a₁, c₁, c₁). In the example illustrated in FIG. 9, since the number of times multiplication is to be repeated for the operand (a₁) is two, the first multiplier 510 may derive a multiplication result ((a₁)²) by repeatedly multiplying (or applying a square calculation to the operand (a₁)) the operand (a₁) two times, and since the number of times multiplication is to be repeated for the operand (a₁) is two, the second multiplier 520 may derive a multiplication result ((a₁)²) by repeatedly multiplying the operand (a₁) two times. Since the number of times multiplication is to be repeated for the operand (c₁) is one, the third multiplier 530 may perform multiplication on the operand (c₁) and “1”. Since the number of times multiplication is to be repeated for the operand (c₁) is one, the fourth multiplier 540 may perform multiplication on the operand (c₁) and “1”.

In the example illustrated in FIG. 9, the number of times multiplication is to be repeated is one, currently, and may be less than the indicated number of times (three times). In this case, the first multiplier 510 may receive the multiplication result ((a₁)²) through the first path 510-1. Similarly, each of the remaining multipliers 520 to 540 may receive a multiplication result through each of the first paths 520-1, 530-1, and 540-1.

The multipliers 510 to 540 may receive the number of times multiplication is to be repeated for each of the operands (e₁, g₁, e₁, g₁) and the operands (e₁, g₁, e₁, g₁) from the operand queue 230-1. Since the number of times multiplication is to be repeated for the operand (c₁) is one, the first multiplier 510 may perform multiplication on the received operand (c₁) and the multiplication result ((a₁)²) received through the first path 510-1 to derive the multiplication result ((a₁)²·e₁). Since the number of times multiplication is to be repeated for the operand (g₁) is one, the second multiplier 520 may perform multiplication on the received operand (g₁) and the multiplication result ((a₁)²) received through the first path 510-1 to derive the multiplication result ((a1) 2 .0. The third multiplier 530 may perform multiplication on the received operand (e₁) and the multiplication result (c₁) received through the first path 530-1 to derive the multiplication result (c₁·e₁), and the fourth multiplier 540 may perform multiplication on the received operand (g₁) and the multiplication result (c₁) received through the first path 540-1 to derive the multiplication result (c₁·g₁).

The number of times multiplication is to be repeated may be two, in this example, and may be less than the indicated number of times (three times). In this case, the first multiplier 410 may receive the multiplication result ((a₁)²·e₁) through the first path 510-1. Similarly, each of the remaining multipliers 520 to 540 may receive a multiplication result through each of the first paths 520-1, 530-1, and 540-1.

The multipliers 510 to 540 may receive the number of times multiplication is to be repeated for the operand (f₁) and the operand (f₁) from the operand queue 230-1. Since the number of times multiplication is to be repeated for the operand (f₁) is one, the first multiplier 410 may perform multiplication on the multiplication result ((a₁)²·e₁) received through the operand (f₁) and the first path 510-1 to derive the multiplication result ((a₁)²·e₁·f₁). Similarly, each of the remaining multipliers 520 to 540 may perform multiplication.

The number of times each of the multipliers 510 to 540 performs multiplication may be three, currently, and may be equal to the indicated number of times (three times). In this case, the first multiplier 510 may transmit the final multiplication result ((a₁)²·e₁·f₁) to the adder 550 and the second multiplier 520 may transmit the final multiplication result ((a₁)²·g₁) to the adder 550. The third multiplier 530 may transmit the final multiplication result (c₁·e₁·f₁) to the adder 560 and the fourth multiplier 540 may transmit the final multiplication result (c₁·g₁) to the adder 560.

The adder 550 may sum the final multiplication result ((a₁)²·e₁·f₁) of the first multiplier 510 and the final multiplication result ((a₁)²·g₁) of the second multiplier 520, and may transmit the sum result to the adder 570.

The adder 560 may sum the final multiplication result (c₁·e₁·f₁) of the third multiplier 530 and the final multiplication result (c₁·g₁) of the fourth multiplier 540, and may transmit the sum result to the adder 570.

The adder 570 may sum the sum result of the adder 550 and the sum result of the adder 560 and may transmit the sum result of the adder 570 itself to the adder 590.

The register 580 may store an operand (i₁) on which multiplication is not performed among operands of the ADPU 350-1.

The adder 590 may receive the operand (i₁) from the register 580, and may perform summing on the sum result of the operand (i₁) and the adder 570.

The adder 590 (or the ADPU 350-1) may store the calculation result (j₁) in the register file 210. Similarly, the ADPU 350-m may store the calculation result (jₘ) in the register file 210. The register file 210 may store a final calculation result of each of the ADPUs 350-1 to 350-m.

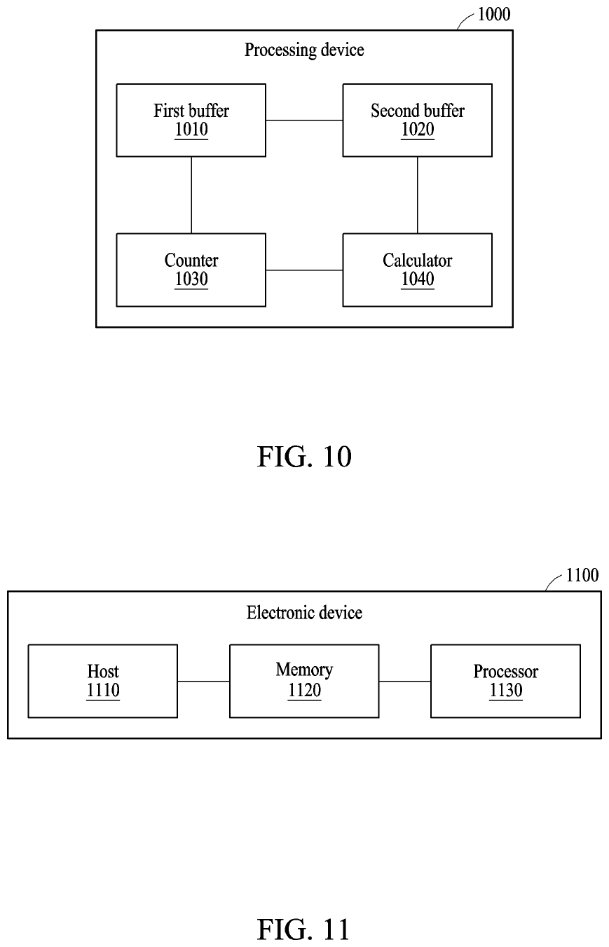

FIG. 10 illustrates a diagram of a processing device according to an example embodiment according to one or more embodiments.

Referring to FIG. 10, a processing device 1000 may include a first buffer 1010, a second buffer 1020, a counter 1030 (or a counter circuit), and a calculator 1040.

The processing device 1000 may correspond to the accelerator 110 (or the processing core 230-1) described above, the first buffer 1010 may correspond to the pattern table 310, the second buffer 1020 may correspond to the inner operand buffer 320, the counter 1030 may correspond to the counter 340, and the calculator 1040 may correspond to the ADPU 350-1.

The first buffer 1010 may store the calculation rules.

The first buffer 1010 may transmit the number of times multiplication is to be performed by each of the multipliers in the calculator 1040 to the counter 1030. The counter 1030 may include a register and may store the number of times received from the first buffer 1010 in the register.

The second buffer 1020 may store operands of the calculator 1040, and enqueue the operands of the calculator 1040 into a queue (e.g., the operand queue 330-1) of the calculator 1040 based on the calculation rules.

The counter 1030 may indicate or communicate the number of times multiplication is to be performed by each of the multipliers to the calculator 1040.

The calculator 1040 may include multipliers that repeatedly perform multiplication and one or more adders. Each of the multipliers may have a first path for an output of each of the multipliers to be input to each of the multipliers when the number of times each multiplier performs multiplication is less than the indicated number of times, and a second path for an output of each of the multipliers to be input to the adder when the number of times each multiplier performs multiplication is equal to the indicated number of times.

Each of the multipliers may receive the derived multiplication result through the first path when the number of times multiplication is performed to derive a multiplication result is less than the indicated number of times, receive an operand corresponding to a current multiplication order from a queue, and perform multiplication on the received multiplication result and the received operand. Each of the multipliers may transmit the derived multiplication result to the adder through the second path when the number of times multiplication is performed deriving a multiplication result is equal to the indicated number of times.

The calculator 1040 may further include a register (e.g., the register 580 of FIG. 5A) that receives and stores an operand (e.g., i₁) on which multiplication is not performed among operands from a queue of the calculator 1040.

The calculator 1040 may sum the operand stored in the register (e.g., the register 580 of FIG. 5) and an output value of the adder.

In a non-limiting example, the calculator 1040 may further include one or more buffers for storing an output of each of the multipliers and an output buffer for storing an output of the adder. In another example, the output buffer may be a third buffer of the calculator. In other examples, the calculator may include one or more, or any number of buffers, to store the various outputs of the multipliers, operands, and outputs from the adder.

When at least one of the multipliers performs a power calculation of a given operand, the second buffer 1020 may map the number of times the given operand is repeatedly multiplied with the given operand and enqueue into the queue.

Descriptions with reference to FIGS. 1 to 9 may apply to what is illustrated in FIG. and thus detailed descriptions thereof will be omitted.

FIG. 11 illustrates a block diagram of an electronic device according to one or more embodiments.

Referring to FIG. 11, an electronic device 1100 may include a host 1110, a memory 1120, and a processor 1130.

The electronic device 1100 may be mounted on various computing devices and/or systems such as a smartphone, a tablet computer, a laptop computer, a desktop computer, a television, a wearable device, a security system, a smart home system, and a data center. The host 1110 may correspond to the host 120 described above, and the processor 1130 may correspond to the processing device 1000 (or the accelerator 110) described above.

The memory 1120 may store operands on which calculations are performed by the processor 1130. The memory 1120 may include a volatile memory (e.g., dynamic random access memory (DRAM)) or a nonvolatile memory.

The processor 1130 may receive a command from the host 1110, receive operands from the memory 1120, and perform a calculation based on the command received from the received operands.

The processor 1130 may include the first buffer 1010 for storing a calculation rule, the calculator 1040 including multipliers that perform multiplication repeatedly and an adder, a second buffer that stores the received operands and enqueues the received operands into the queue of the calculator 1040 based on the calculation rule, and the counter 1030 indicating the number of times multiplication is to be performed by each of the multipliers to the calculator 1040.

Descriptions with reference to FIGS. 1 to 10 may apply to what is illustrated in FIG. 11, and thus detailed descriptions thereof will be omitted.

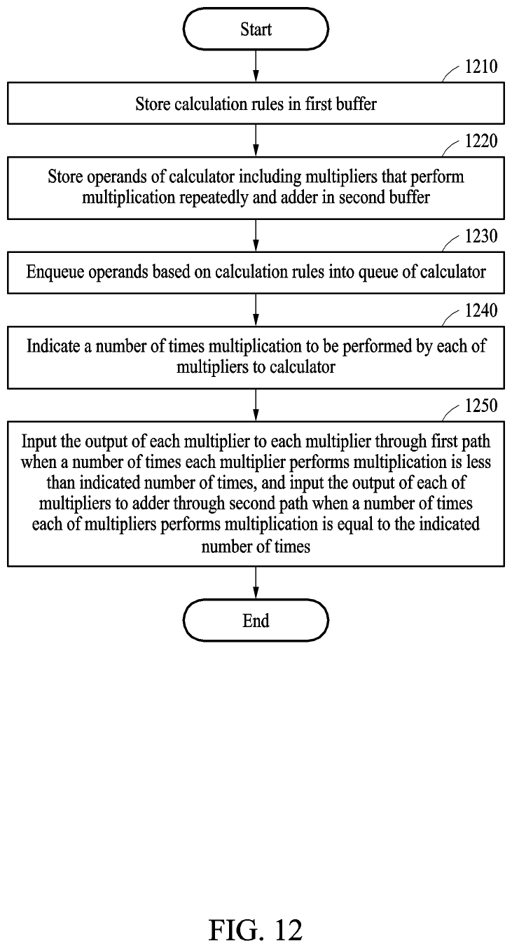

FIG. 12 illustrates a flowchart of a method of operating a processing device according to an example embodiment.

Referring to FIG. 12, in operation 1210, the processing device 1000 may store the calculation rules in the first buffer 1010.

In operation 1220, the processing device 1000 may store multipliers that perform multiplication repeatedly and operands of the calculator 1040 including the adder in the second buffer 1020.

In operation 1230, the processing device 1000 may enqueue operands based on the calculation rules into the queue of the calculator 1040. In operation 1240, the processing device 1000 may indicate to the calculator 1040 the number of times multiplication is to be performed by each of the multipliers.

In operation 1250, when the number of times each of the multipliers performs multiplication is less than the indicated number of times, the processing device 1000 may input the output of each of the multipliers to each of the multipliers through the first path, and input the output of each of the multipliers to the adder through the second path when the number of times each of the multipliers performs multiplication is equal to the indicated number of times.

Descriptions with reference to FIGS. 1 to 11 may apply to what is illustrated in FIG. 12, and thus detailed descriptions thereof will be omitted.

The electronic devices, processors, memories, electronic device 10, accelerator 110, host 120, processing cores, multipliers, buffers, electronic device 1000, host 1110, memory 1120, and processor 1130 described herein and disclosed herein described with respect to FIGS. 1-12 are implemented by or representative of hardware components. As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. As described above, or in addition to the descriptions above, example hardware components may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-12 that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media, and thus, not a signal per se. As described above, or in addition to the descriptions above, examples of a non-transitory computer-readable storage medium include one or more of any of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD- Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks , and/or any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A processing device, comprising:
a first buffer storing calculation rules;
a calculator comprising a plurality of multipliers and an adder, each of the plurality of multipliers being configured to perform multiplication repeatedly;
a second buffer storing operands of the calculator, the second buffer being configured to enqueue the operands based on the calculation rules into a queue of the calculator; and
a counter indicating a respective number indicating a number of times a multiplication is to be performed by each of the plurality of multipliers, wherein each multiplier of the plurality of multipliers is configured to:
provide a non-final multiplication result to a first path to an input of a corresponding multiplier responsive to a corresponding number of multiplications performed by the corresponding multiplier being less than the respective number; and
provide a final multiplication result to a second path to the adder responsive to the corresponding number of multiplications performed by the corresponding multiplier being equal to the respective number.

2. The processing device of claim 1, wherein each of the plurality of multipliers is configured to, upon receiving the non-final multiplication result through the first path:
receive an operand corresponding to a current multiplication order from the queue; and
perform multiplication on the non-final multiplication result and the received operand.

3. The processing device of claim 2, wherein each of the plurality of multipliers is configured to, when the corresponding number multiplications performed is equal to the indicated number of times, transmit a derived multiplication result, as the final multiplication result, to the adder through the second path.

4. The processing device of claim 1, wherein the calculator further comprises:
a register receiving and storing an added operand on which multiplication is not to be performed among the operands from the queue. The processing device of claim 4, wherein the calculator is configured to sum the added operand stored in the register and an output value of the adder.

6. The processing device of claim 1, wherein the first buffer is configured to transmit the number of times multiplication is to be performed by each of the plurality of multipliers to the counter.

7. The processing device of claim 1, wherein the second buffer is configured to, when at least one multiplier of the plurality of multipliers performs a power calculation of a given operand, map a number of times the given operand is repeatedly multiplied with the given operand and enqueue the given operand into the queue.

8. The processing device of claim 1, wherein each of the first buffer and second buffer are configured to store an output of each of the plurality of multipliers, and wherein the calculator further comprises a third buffer storing an output of the adder.

9. An electronic device, comprising:
a host processor;
a memory storing operands; and
a processor configured to receive a command from the host processor, receive the operands from the memory, and perform a calculation on the received operands based on the received command,
wherein the processor comprises:
a first buffer storing calculation rules;
a calculator comprising a plurality of multipliers an adder, each of the plurality of multipliers being configured to perform multiplication repeatedly;
a second buffer storing the received operands and enqueuing the received operands based on the calculation rules into a queue of the calculator; and
a counter indicating a number of times a multiplication is to be performed by each of the plurality of multipliers,
wherein each of the plurality of multipliers is configured to:
provide to a first path to be input to each of the plurality of multipliers responsive to a corresponding number of multiplications performed by the multiplier being less than the respective number; and
provide to a second path to be input to the adder responsive to the number of multiplications performed by the multiplier is equal to the respective number.

10. The electronic device of claim 9, wherein each of the plurality of multipliers is configured to:
responsive to a number of multiplications performed by the multiplier is less than the respective number receive a derived multiplication result through the first path;
receive an operand corresponding to a current multiplication order from the queue; and
perform multiplication on the derived multiplication result and the received operand.

11. The electronic device of claim 10, wherein each of the plurality of multipliers is configured to, responsive to the corresponding number of multiplications performed by the multiplier is equal to the respective number, transmit the derived multiplication result to the adder through the second path.

12. The electronic device of claim 9, wherein the calculator further comprises:
a register receiving and storing an added operand on which multiplication is not to be performed from the queue among the operands enqueued into the queue.

13. The electronic device of claim 12, wherein the calculator is configured to sum the added operand stored in the register and an output value of the adder.

14. The electronic device of claim 9, wherein the first buffer is configured to transmit the number of times the multiplication is to be performed by each of the plurality of multipliers to the counter.

15. The electronic device of claim 9, wherein the second buffer is configured to, when at least one multiplier of the plurality of multipliers performs a power calculation of a given operand, map a number of times the given operand is repeatedly multiplied with the given operand and enqueue the given operand into the queue.

16. The electronic device of claim 9, wherein the calculator further comprises:
a plurality of buffers configured to store an output of each of the plurality of multipliers, respectively; and
an output buffer configured to store an output of the adder.

17. The electronic device of claim 9, wherein the host processor is configured to generate the calculation rules while compiling source code, and
wherein the processor is configured to store the calculation rules in the first buffer.

18. A processor implemented method, the method comprising:
enqueuing operands based on calculation rules into a queue of a calculator;
indicating a number of times multiplication is to be performed by each of a plurality of multipliers;
providing a non-final output, for each of the plurality of multipliers, through a first path to an input of the respective multiplier; and
providing a final output, for each of the plurality of multipliers to an adder through a second path.

19. The method of claim 18, further comprising:
mapping a number of times a given operand is repeatedly multiplied with the given operand and enqueueing the given operand into the queue when at least one of the multipliers performs a power calculation of a given operand.

20. The method of claim 18, wherein each of the plurality of multipliers is configured to:
provide to the first path responsive to a number of multiplications performed being less than the indicated number; and
provide to the second path responsive to the number of multiplications performed being equal to the indicated number.
